(19) United States
(12) Patent Application Publication
(10) Pub. No.: US 2018/0038592 A1
(43) Pub. Date: Feb. 8, 2018

(54) Gas Switching Device And Associated Methods

(71) Applicant: Hayward Industries, Inc., Elizabeth, NJ (US)

(72) Inventors: Vance Elliot Willis, Nunnelly, TN (US); Michael Damion Mercer, Nashville, TN (US); Benjamin Isaac Corn, Nashville, TN (US)

(73) Assignee: Hayward Industries, Inc., Elizabeth, NJ (US)

(21) Appl. No.: 15/658,726

(22) Filed: Jul. 25, 2017

Related U.S. Application Data
(60) Provisional application No. 62/370,857, filed on Aug. 4, 2016.

(51) Int. Cl. F23N 1/00; F23C 1/00; F16K 31/60; F16K 1/12; F16K 31/524

(52) U.S. Cl. CPC F23N 1/007; F16K 1/12; F16K 31/52408; F16K 31/602; F23C 1/00

(57) ABSTRACT

Exemplary embodiments are directed to a gas switching device including a body and a gas selector mechanism. The body includes an inlet and an outlet. The gas selector mechanism includes a first orifice in fluid communication with the inlet and a second orifice in fluid communication with the inlet. The gas selector mechanism includes a valve arm and a selector element. The selector element is configured to actuate the valve arm between a closed position and an open position. In the closed position, the selector element actuates the valve arm to close the second orifice for passage of a first type of gas through the first orifice. In the open position, the selector element actuates the valve arm to open the second orifice for passage of a second type of gas through both the first orifice and the second orifice.

### CROSS-REFERENCE TO RELATED APPLICATIONS

The present application claims the benefit of priority to, U.S. Provisional Patent Application No. 62/370,857, filed Aug. 4, 2016, and the entire contents of the foregoing application are incorporated herein by reference.

### TECHNICAL FIELD

The present disclosure relates to gas switching devices and associated methods and, in particular, to gas switching devices that allow for selection between two different gas types without a required modification to a gas injection system.

### BACKGROUND

Gas heaters for swimming pools generally include a combustion system that can accept a variety of fuel gases, such as natural gas and propane gas. To convert a gas pool heater from one fuel gas to another, a modification to the gas injection system is generally needed. Such modifications can include changing one or multiple gas injectors or orifices, necessitating tools and expertise in the procedure by, e.g., an installer. Due to the complexity of such modifications, swimming pool heater manufacturers generally produce multiple pool heater models preset to different fuel gasses to simplify the process of having the installer switch between different fuel gases.

A further attempt to simplify the process of switching between different gases includes an installation of both gas orifices, and a valve that allows one of the two orifices to be selected by the installer. A diagrammatic view of a traditional gas switching system 10 is shown in FIG. 1. In particular, the gas switching system 10 includes a gas inlet 12 and a gas outlet 14. The gas switching system 10 generally includes a first orifice 16 sized to control flow of a first type of gas, and a second orifice 18 sized to control flow of a second type of gas. The gas switching system 10 further includes a 3-way valve 20 that can be used by the installer to select which of the orifices 16, 18 is to be used. In particular, the 3-way valve 20 can be disposed at an intersection of the gas inlet 12, a pipe or path leading to the first orifice 16, and a pipe or path leading to the second orifice 18, thereby regulating flow to both the first and second orifices 16, 18. For example, for propane gas, the 3-way valve 20 can be switched to direct gas flow through the first orifice 16. As a further example, for natural gas, the 3-way valve 20 can be switched to direct gas flow through the second orifice 18.

However, such traditional valves 20 may inadvertently be positioned between a fully open and a fully closed position, allowing passage of gas through both the first and second orifices 16, 18, leading to improper gas flow. Excessive gas flow into the gas injection system due to improper gas flow can result in overheating and production of excessive, unwanted exhaust emissions, such as carbon monoxide. Further, if the 3-way valve 20 fails, excessive gas flow could pass through both the first and second orifices 16, 18, resulting in damage to the gas injection system. In particular, due to the independent sizing of the first and second orifices 16, 18 for the first and second types of gas, respectively, if the 3-way valve 20 fails during use of any type of gas, the gas injection system would receive excessive amounts of gas, resulting in damage to the gas injection system.

Thus, a need exists for gas switching devices that allow for selection between two types of gases without modifying the gas injection system. A need further exists for gas switching devices that ensure that the valve is positioned in either a fully open or a fully closed position. These and other needs are addressed by the gas switching devices and associated methods of the present disclosure.

### SUMMARY

In accordance with embodiments of the present disclosure, an exemplary gas switching device is provided that includes a body and a gas selector mechanism. The body includes an inlet and an outlet. In some embodiments, the inlet of the body can include a connection mechanism. The connection mechanism can include a circumferential flange and a circumferential groove configured and dimensioned to receive an O-ring. The connection mechanism can be configured to mate with a gas source. The body further includes a first orifice in fluid communication with the inlet and a second orifice in fluid communication with the inlet. In some embodiments, the first and second orifices are of the same size. In some embodiments, the first and second orifices are of different sizes. The gas selector mechanism includes a valve arm and a selector element (e.g., a lever, a knob, a handle, or the like).

The selector element can be configured to actuate the valve arm between a closed position and an open position. In the closed position, the selector element actuates the valve arm to close the second orifice for passage of a first type of gas through the first orifice. In the open position, the selector element actuates the valve arm to open the second orifice for passage of a second type of gas through both the first orifice and the second orifice. In some embodiments, in the open position, the second type of gas passes through both the first orifice and the second orifice substantially simultaneously.

The first orifice can be calibrated for passage of the first type of gas. A combination of the first orifice and the second orifice can be calibrated for passage of the second type of gas. In some embodiments, the first type of gas can be liquefied petroleum gas (e.g., propane gas). In some embodiments, the second type of gas can be natural gas.

In some embodiments, the selector element can include a selector valve, the selector valve including a lever arm and a cam. The gas switching device includes a gas selector cover including an opening restricting rotational motion of the lever arm of the selector lever to a predetermined radial distance. The predetermined radial distance can include a first endpoint position and a second endpoint position. In some embodiments, the predetermined radial distance can be approximately 90°. The first endpoint position can correspond to the closed position of the valve arm. The second endpoint position can correspond to the open position of the valve arm.

The valve arm includes a central opening configured and dimensioned to receive the cam of the selector valve. In some embodiments, the cam can define a half-circle cross-section or configuration with two flat edges. The two flat edges can be adjacently disposed at an approximately 90° angle. The two flat edges can snap the cam into a position corresponding to either the first endpoint position or the second endpoint position of the valve arm, and prevent the cam from being positioned between the first endpoint position and the second endpoint position.

The gas switching device can include a spring imparting pressure on the valve arm. Rotating the lever arm into the first endpoint position can expand the spring to impart pressure on the valve arm. The pressure on the valve arm forces the valve arm to translate and close the second orifice. Rotating the lever arm into the second endpoint position can translate the valve arm away from the second orifice (based on interaction of the cam with the central opening of the valve arm) and compresses the spring to open the second orifice.

In accordance with embodiments of the present disclosure, an exemplary gas switching device is provided that includes a body, a first orifice, a second orifice, a valve arm, and a selector element. The body includes an inlet. The first orifice can be in fluid communication with the inlet. The second orifice can be in fluid communication with the inlet. The selector element can be configured to actuate the valve arm between a closed position and an open position to close and open the second orifice, respectively. The selector element includes a cam defining a half-circle cross-section or configuration with two flat edges.

In accordance with embodiments of the present disclosure, an exemplary method of switching gas is provided. The method includes providing a gas switching device as described herein. The method includes actuating the valve arm with the selector element into a closed position to close the second orifice for passage of a first type of gas through the first orifice. The method includes actuating the valve arm with the selector element into an open position to open the second orifice for passage of a second type of gas through both the first orifice and the second orifice.

The method can include restricting rotational motion of the selector element (e.g., a lever arm of the selector element) with an opening of a gas selector cover to a predetermined radial distance. The predetermined radial distance can include a first endpoint position and a second endpoint position. The method can include rotating the selector element (e.g., the lever arm of the selector element) into the first endpoint position to expand a spring imparting pressure on the valve arm such that the spring imparts pressure on the valve arm to force the valve arm to translate and close the second orifice. The method can include rotating the selector element (e.g., the lever arm of the selector element) into the second endpoint position to translate the valve arm away from the second orifice and compress the spring to open the second orifice.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed gas switching devices and associated methods, reference is made to the accompanying figures, wherein:

FIG. 1 is a diagrammatic view of a traditional gas switching device in accordance with the prior art.

FIG. 2 is a diagrammatic view of an exemplary gas switching device in accordance with embodiments of the present disclosure.

FIG. 3 is a perspective view of a first embodiment of an exemplary gas switching device in accordance with embodiments of the present disclosure.

FIG. 4 is an exploded, perspective view of a first embodiment of an exemplary gas switching device of FIG. 3.

FIG. 5 is a cross-sectional view of a first embodiment of an exemplary gas switching device of FIG. 3 in a first position.

FIG. 6 is a cross-sectional view of a first embodiment of an exemplary gas switching device of FIG. 3 in a second position.

FIG. 7 is a detailed, bottom view of a cam of a first embodiment of an exemplary gas switching device of FIG. 3.

FIG. 8 is a perspective view of a prototype of a first embodiment of an exemplary gas switching device in accordance with embodiments of the present disclosure.

FIG. 9 is a perspective view of a prototype of a first embodiment of an exemplary gas switching device of FIG. 8 mounted to a gas valve and a blower of a swimming pool heater.

FIG. 10 is a side view of a second embodiment of an exemplary gas switching device in accordance with embodiments of the present disclosure.

FIG. 11 is a cross-sectional view of a second embodiment of an exemplary gas switching device of FIG. 10 mated with a gas source.

FIG. 12 is a side view of a connection mechanism between a second embodiment of an exemplary gas switching device and a gas source in accordance with embodiments of the present disclosure.

FIG. 13 is a perspective view of an assembled connection mechanism of FIG. 12.

FIG. 14 is a side view of an assembled connection mechanism of FIG. 12.

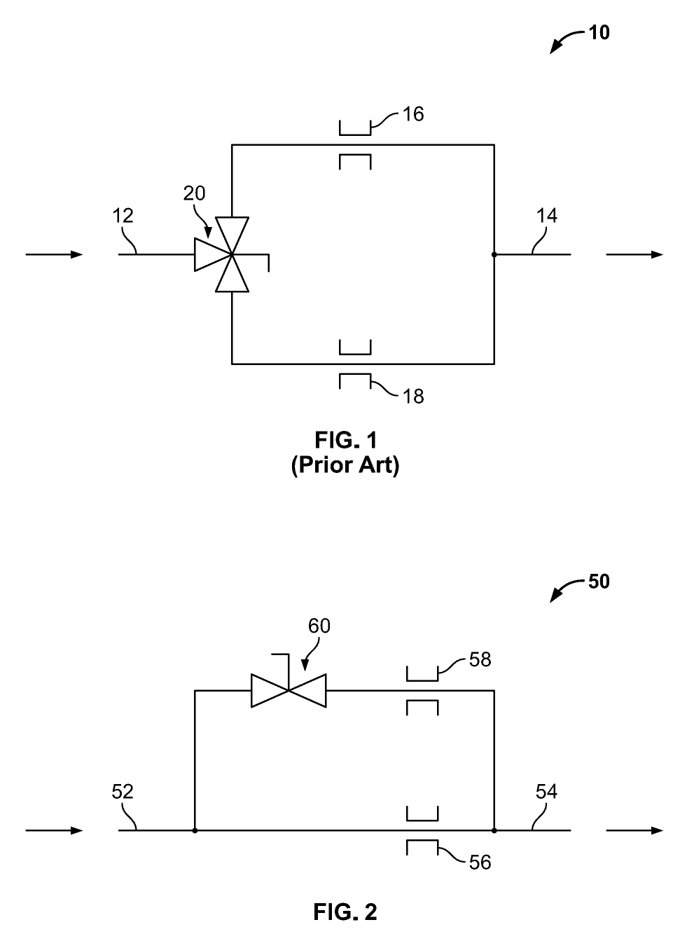

### DESCRIPTION OF EXEMPLARY EMBODIMENTS

In accordance with embodiments of the present disclosure, exemplary gas switching devices are provided that allow for selection between two types of gases without modifying the gas injection system. In particular, the gas switching devices can be positioned into a first position for use of a first orifice for one gas type, and can be positioned into a second position for use of a combination of the first orifice and a second orifice for a second gas type. The exemplary gas switching devices further include a system for positioning a valve in either a fully open or a fully closed position (not an intermediate position), ensuring proper gas flow.

With reference to FIG. 2, a diagrammatic view of an exemplary gas switching device 50 (hereinafter “device 50”) is provided. The device 50 includes an inlet 52 and an outlet 54. The device 50 includes a first path or piping leading to a first orifice 56. The first orifice 56 can be sized or calibrated for the desired flow of a first type of gas, e.g., propane gas. The device 50 includes a second path or piping leading to a second orifice 58. The second orifice 58, in combination or in parallel with the first orifice 56, can be sized or calibrated for the desired flow of a second type of gas, e.g., natural gas. The device 50 includes a gas selector mechanism including a 2-way valve 60 associated with the second path or piping leading to the second orifice 58. Thus, rather than being disposed at an intersection of the first and second paths or piping and regulating flow to both the first and second orifices 56, 58, the 2-way valve 60 can be actuated to regulate flow only to the second orifice 58. In addition, the 2-way valve 60 is more cost effective and provides for a simpler design than traditional 3-way valves, resulting in less potential maintenance issues.

During operation, if the gas injection system is using a first type of gas (e.g., propane gas), the 2-way valve 60 can be actuated into a closed position. Propane gas flowing from the inlet 52 passes only through the first orifice 56 and exits the device 50 through the outlet 54. Due to the calibrated size of the first orifice 56, the proper amount of propane gas passes through the outlet 54. If the injection system is using a second type of gas (e.g., natural gas), the 2-way valve 60 can be actuated into an open position. Natural gas flowing from the inlet 52 passes through both the first and second orifices 56, 58 in parallel and substantially simultaneously, and exits the device 50 through the outlet 54. Due to the calibrated size of the first and second orifices 56, 58, the combination of natural gas flowing through the first and second orifices 56, 58 results in the proper amount of natural gas passing through the outlet 54.

Sizing or calibration of the orifices 56, 58 for natural gas and propane (or any fuel gas) can be based on the heating value or heat content of the fuel gas. Heating value units can be in energy per unit volume, such as Btu per cubic foot (CF). In general, natural gas (e.g., methane gas) has a heating value of approximately 1,000 Btu/CF, and propane gas has a heating value of approximately 2,500 Btu/CF. For example, if generation of 250,000 Btu per hour of heat energy is desired from combustion of a fuel gas, approximately 100 CF of propane gas should be burned per hour or 250 CF of natural gas per hour. Thus, different volumetric flow rates are needed for each type of gas. In order to take into account the different volumetric flow rates of the types of gases being used, an equation can be used for sizing the gas orifices 56, 58. The equation generally takes into account the injection pressure (regulated by a pressure regulator in a gas control valve), the specific gravity of the gas, the heating value of the gas, and the desired heat output rate. The equation also has a “K” factor which varies depending on the orifice geometry. Therefore, the equation can be used to estimate the orifice 56, 58 size. In some embodiments, tests can be conducted using a calibrated gas flow meter to determine the orifice 56, 58 size precisely.

In terms of safety, even if the 2-way valve 60 failed, the maximum amount of flow would be limited to the size of both the first and second orifices 56, 58. For example, if the gas combustion system is utilizing propane gas, failure of the 2-way valve 60 would result in excessive propane gas passing through the outlet 54, leading to potential damage of the gas combustion system. However, if the gas combustion system is utilizing natural gas, failure of the 2-way valve 60 would maintain the proper amount of natural gas passing through both the first and second orifices 56, 58, preventing damage to the gas combustion system.

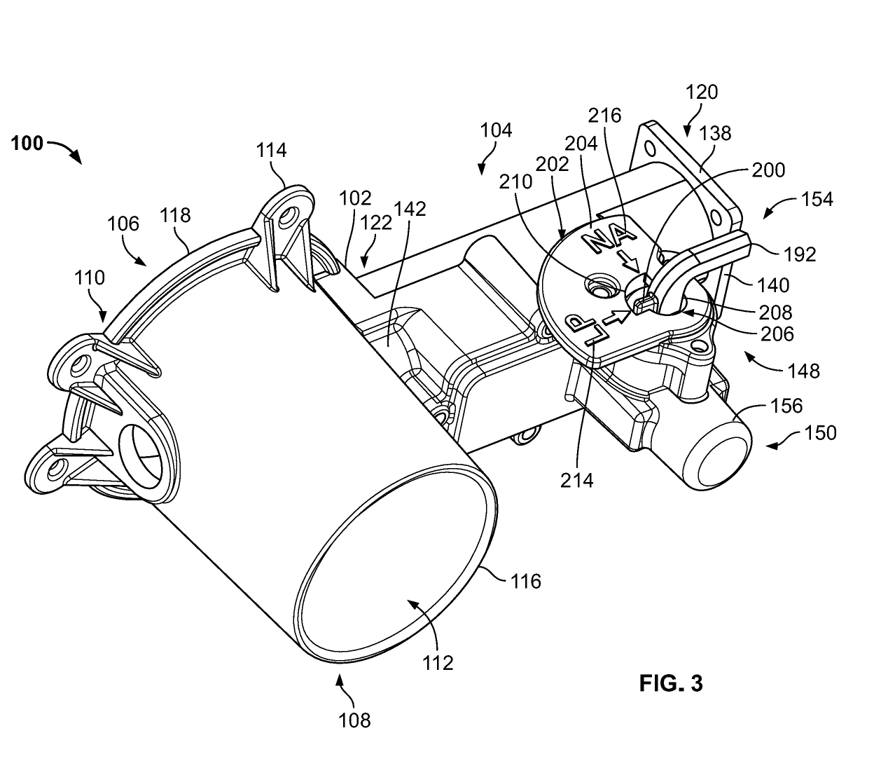

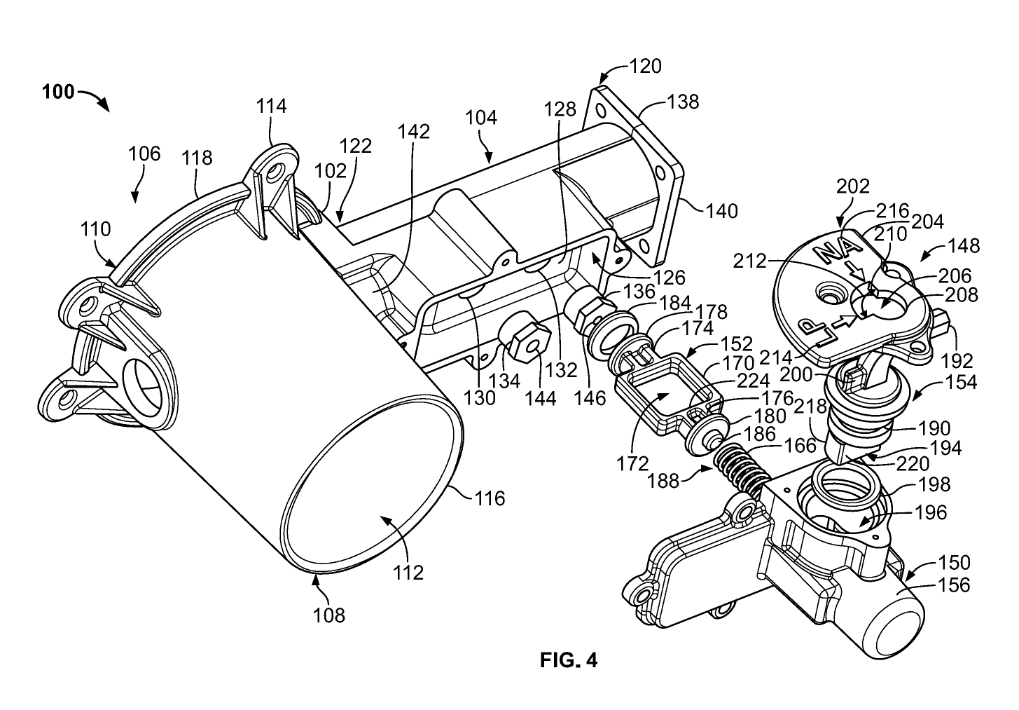

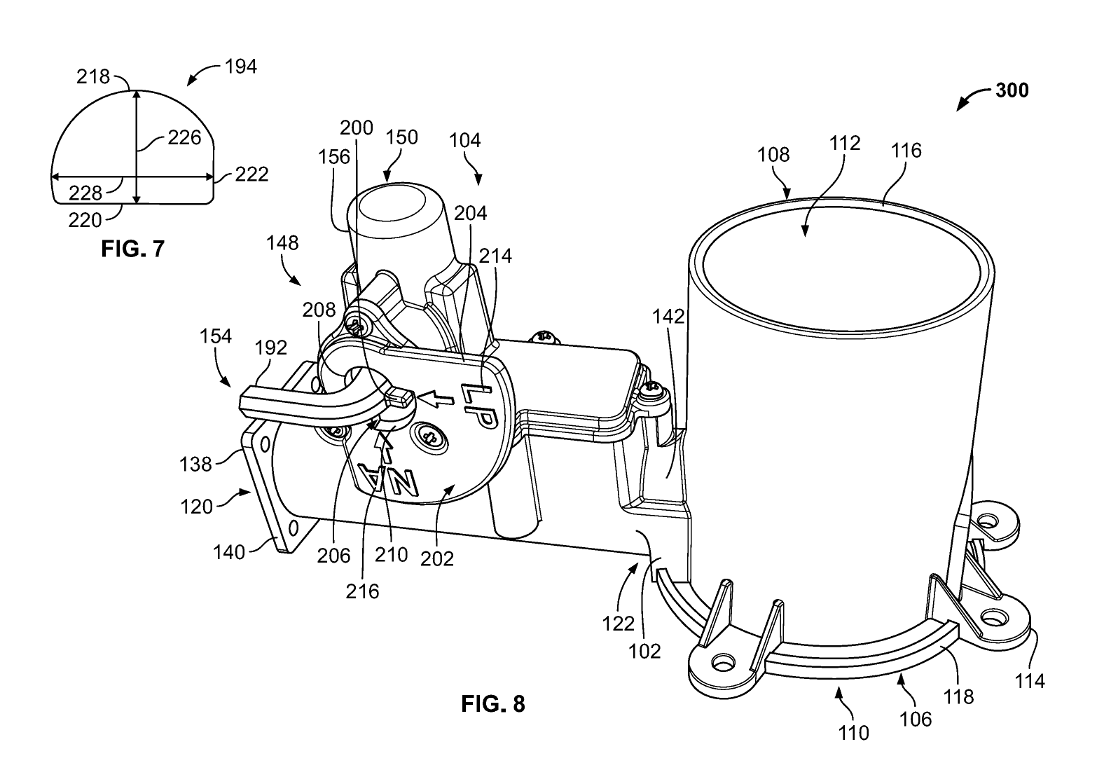

With reference to FIGS. 3-7, perspective, exploded, cross-sectional and detailed views of a first embodiment of an exemplary gas switching device 100 (hereinafter “device 100”) are provided. The device 100 includes a body 102 including a valve section 104 and a venturi section 106. In some embodiments, the valve section 104 can be disposed substantially perpendicular to the venturi section 106. The venturi section 106 defines a proximal end 108 and a distal end 110, with a passage 112 extending between the proximal and distal ends 108, 110. In some embodiments, the venturi section 106 can define a substantially cylindrical configuration. In some embodiments, the venturi section 106 can taper gradually, with the diameter of the proximal end 108 being dimensioned smaller than the diameter of the distal end 110. The venturi section 106 can include a circumferential flange 114 extending around the perimeter of the distal end 110. The circumferential flange 114 can be used to mount the venturi section 106 to surrounding structures or equipment. The proximal end 108 can serve as a venturi inlet 116 for air passing through the device 100, and the distal end 110 can serve as an outlet 118 for both the venturi section 106 and the device 100.

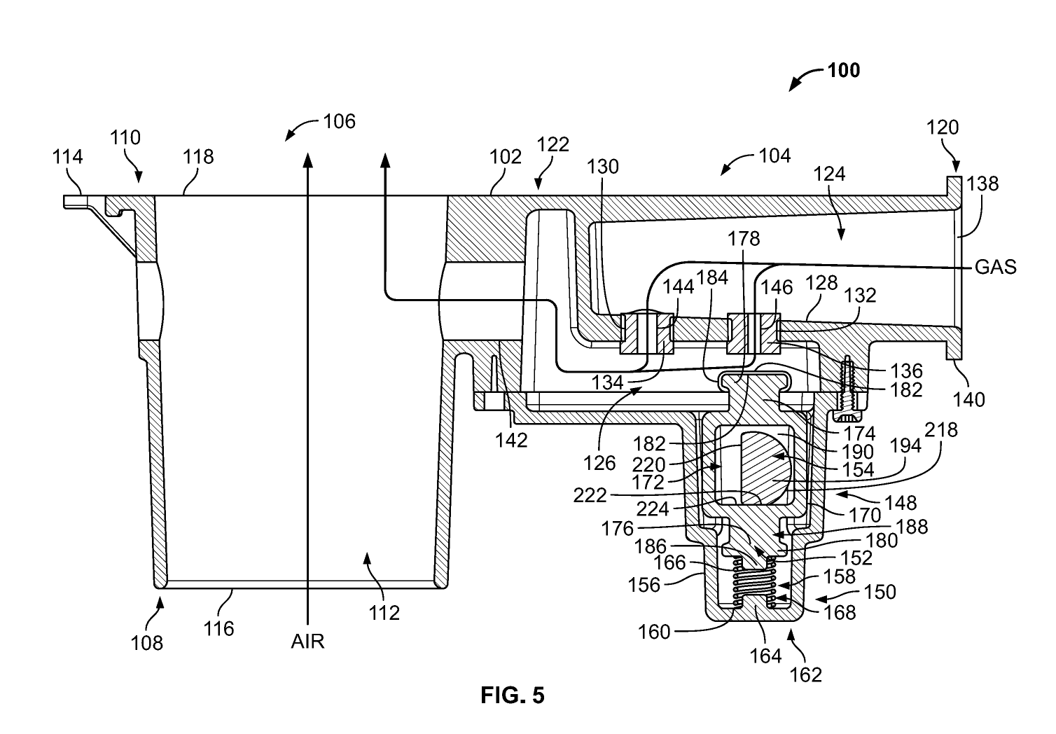

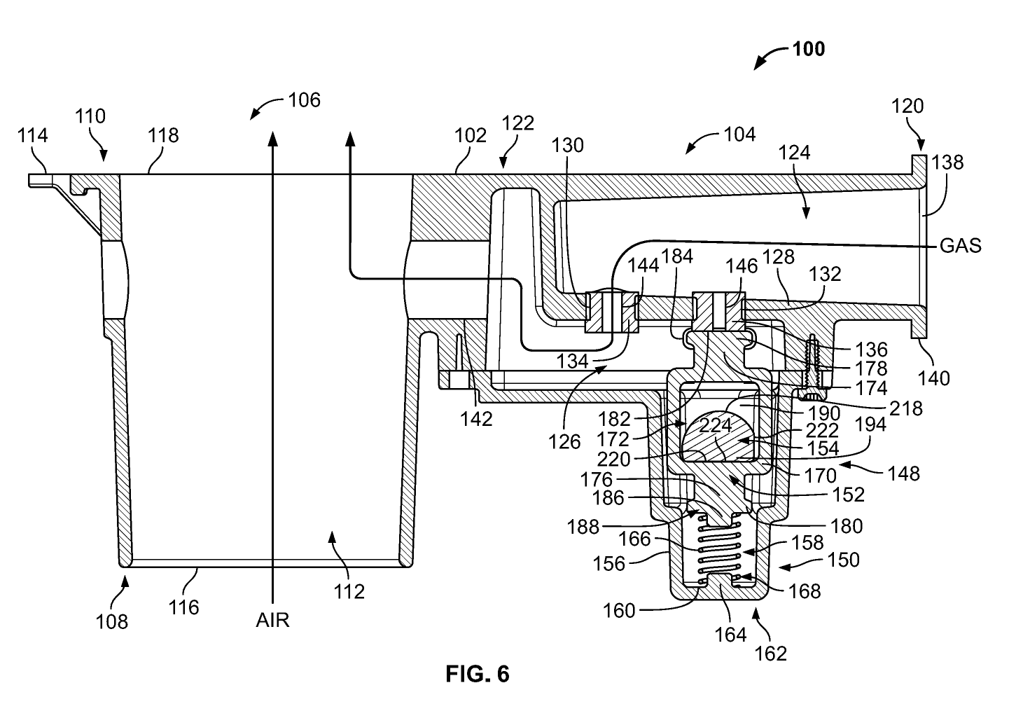

The valve section 104 defines a proximal end 120 and a distal end 122. The valve section 104 includes a first chamber or passage 124 extending from the proximal end 120 a partial distance in the direction of the distal end 122 (e.g., halfway, three-fourths, or the like). The valve section 104 further includes a second chamber or passage 126 disposed adjacent to the first passage 124 and separated by a wall 128. In some embodiments, the second passage 126 can define a substantially L-shaped cross-sectional configuration, as shown in the side, cross-sectional views of FIGS. 5 and 6. The valve section 104 includes first and second openings 130, 132 formed in the wall 128 and fluidly connecting the first and second passages 124, 126. The first and second openings 130, 132 can be adjacently disposed relative to each other. The first and second openings 130, 132 can be dimensioned the same and are configured and dimensioned to receive first and second fittings 134, 136, which will be discussed in greater detail below.

The proximal end 120 of the valve section 104 can serve as an inlet 138 for the valve section 104 and the device 100. The proximal end 120 can include a circumferential flange 140 extending around the perimeter of the proximal end 120. The circumferential flange 140 can be used to mount the valve section 104 to surrounding structures or equipment (e.g., a gas valve or source). The body 102 includes a connecting passage 142 formed therein. The connecting passage 142 can provide fluid communication between the second passage 126 and the passage 112 of the venturi section 106. In particular, gas can enter the device 100 through the inlet 138 of the valve section 104 into the first passage 124, flows through one or both of the first and second fittings 134, 136 into the second passage 126, flows through the passage 142 into the passage 112 of the venturi section 106, and exits the device 100 through the outlet 118 with air passing through the venturi section 106.

Each of the first and second fittings 134, 136 can be configured to mount within the openings 130, 132. In some embodiments, the fittings 134, 136 can include outer threads complementary to threads of the openings 130, 132 such that the first and second fittings 134, 136 can be threaded into the first and second openings 130, 132. Mounting of the fittings 134, 136 into the openings 130, 132 creates a fluid-tight seal between the fittings 134, 136 and openings 130, 132. Thus, if necessary, fittings 134, 136 can be interchanged depending on the types of gases to be used with the device 100. In particular, the first fitting 134 includes a first orifice 144 centrally formed therein, and the second fitting 136 includes a second orifice 146 centrally formed therein.

The first and second orifices 144, 146 create fluid communication between the first and second passages 124, 126 of the valve section 104 when the fittings 134, 136 are secured within the openings 130, 132. The diameter of the first orifice 144 can be sized or calibrated for passage of a first type of gas, e.g., propane gas. The diameter of the second orifice 146 can be sized or calibrated (in combination with the first orifice 144) for passage of a second type of gas, e.g., natural gas. For example, when the gas injection system is using propane gas, the second orifice 146 can be closed and the propane gas can flow through only the first orifice 144, the size of the second orifice 146 being dimensioned for proper flow of the propane gas (see, e.g., FIG. 6). As a further example, when the gas injection system is using natural gas, the second orifice 146 can be opened and the natural gas can flow through both the first and second orifices 144, 146, the combination in size of the first and second orifices 144, 146 being dimensioned for proper flow of the natural gas (see, e.g., FIG. 5). Thus, in some embodiments, the fittings 134, 136 can be interchanged with fittings having different orifice sizes if gases other than propane gas and natural gas are to be used. In some embodiments, rather than interchanging the fittings 134, 136 to vary the size of the first and second orifices 144, 146, the openings 130, 132 themselves can be calibrated to regulate gas flow without the need to use the fittings 134, 136.

The device 100 includes a gas selector mechanism 148 for regulating the open and closed configuration of the second orifice 146. The gas selector mechanism 148 can include a gas selector housing 150, a valve arm 152 and a selector element 154. Although illustrated as having a selector lever, it should be understood that the selector element 154 can be any type of actuator, e.g., a knob, handle, or the like. The gas selector housing 150 can include a substantially cylindrical portion 156 including an inner chamber 158 configured and dimensioned to receive at least a portion of the valve arm 152. An inner surface 160 of the distal end 162 of the cylindrical portion 156 includes a central protrusion 164 extending therefrom. The central protrusion 164 can define a cylindrical configuration. The gas selector mechanism 148 includes a spring 166 disposed within the cylindrical portion 156. The spring 166 can be positioned against the inner surface 160 with a distal end 168 of the spring 166 surrounding the central protrusion 164. The central protrusion 164 can maintain the spring 166 centered relative to the cylindrical portion 156.

The valve arm 152 includes a central body 170 (e.g., a rectangular central body) and a central opening 172 formed in the central body 170. The central opening 172 can define a substantially rectangular configuration. The valve arm 152 includes first and second protrusions 174, 176 extending from opposing sides of the central body 170. Each protrusion 174, 176 can include a circular flange 178, 180 defining the end of the protrusion 174, 176. The first flange 178 can define a substantially planar surface 182. In some embodiments, a boot 184 (e.g., a rubber boot valve seal) can be mounted over the planar surface 182 to assist in creating a fluid-tight seal between the valve arm 152 and the second orifice 146. The second flange 180 can include an extension 186 formed thereon. A proximal end 188 of the spring 166 can surround the extension 186, thereby cooperating with the central protrusion 164 to maintain the spring 166 centered relative to the cylindrical portion 156. As will be discussed in greater detail below, the spring 166 continuously maintains pressure on the valve arm 152, biasing the valve arm 152 in the direction of the second orifice 146. Depending on the rotational position of the selector element 154, the valve arm 152 can close or open the second orifice 146.

The selector element 154 includes a selector body 190, a lever arm 192 extending from one end of the selector body 190, and a cam 194 extending from an opposing end of the selector body 190. The lever arm 192 and at least part of the selector body 190 can be disposed within an opening 196 formed in the gas selector housing 150. The opening 196 can connect with the inner chamber 158, thereby allowing the cam 194 to engage the central opening 172 of the valve arm 152. The opening 196 can be disposed substantially tangentially relative to the inner chamber 158. An O-ring 198 can be disposed between the selector body 190 and the gas selector housing 150 to create a fluid-tight seal.

The lever arm 192 can include a flange 200 extending therefrom. In some embodiments, the gas selector mechanism 148 can include a gas selector cover 202 mounted over the selector body 190 and onto the gas selector housing 150. The gas selector cover 202 can define a substantially planar body 204 including an aperture 206 passing therethrough. The aperture 206 can include a circular portion 208 configured to allow passage of the lever arm 192, and a radial portion 210 extending from the circular portion 208. The radial portion of the aperture 206 can define a predetermined radial distance 212. In some embodiments, the predetermined radial distance 212 can be approximately 90° (e.g., a ¼ turn). When assembled, the lever arm 192 can pass through the circular portion 208 of the aperture 206 and the flange 200 of the lever arm 192 can pass through the radial portion 210 of the aperture 206. As the lever arm 192 is rotated, the flange 200 rotates within the radial portion 210 along the predetermined radial distance 212. In particular, the rotation of the flange 200 (and thereby rotation of the lever arm 192) is limited by the predetermined radial distance 212 between first and second endpoint positions of the radial portion 210 of the aperture 206.

The body 204 of the gas selector cover 202 can include first and second labels 214, 216 mounted or formed in the body 204. The first label 214 (e.g., “LP” corresponding with liquefied petroleum or propane gas) can correspond with the first endpoint position and the closed position of the valve arm 152 (e.g., the second orifice 146 is closed). The second label 216 (e.g., “NA” corresponding with natural gas) can correspond with the second endpoint position and the open position of the valve arm 152 (e.g., the second orifice 146 is open). Thus, due to the gas selector cover 202, the lever arm 192 is restricted to a predetermined radial motion (e.g., approximately 90°).

With specific reference to FIGS. 5-7, the cam 194 (when viewed from the bottom) defines a half-circle configuration with two flat edges. In particular, the cam 194 includes a half-circle section 218, a first flat edge 220, and a second flat edge 222. The first flat edge 220 can oppose the half-circle section 218. The first and second flat edges 220, 222 can be adjacently disposed relative to each other at an approximately 90° angle, resulting in an L-shaped configuration. In particular, the second flat edge 222 can cut off a portion of the half-circle section 218. The configuration of the cam 194 results in a first distance 226 between the first flat edge 220 and the half-circle section 218, and a second distance 228 between the second flat edge 222 and the half-circle section 218. The second distance 228 can be measured transverse to the first distance 226. The second distance 228 is dimensioned greater than the first distance 226. The first and second flat edges 220, 222 engage the inner surfaces of the central opening 172 of the valve arm 152 to maintain the valve arm 152 in the closed or open position. Due to the difference in size of the first and second distances 226, 228, rotation of the cam 194 varies the engagement with the valve arm 152 and whether the spring 166 is compressed or allowed to expand. During rotation of the cam 194 within the central opening 172 of the valve arm 152, the rounded configuration of the half-circle section 218 engages inner surfaces of the central opening 172 to allow for smooth rotation of the cam 194 and actuation of the valve arm 152.

In particular, in the closed position (e.g., the second orifice 146 is closed), the lever arm 192 can be rotated to the first endpoint position, resulting in rotation of the cam 194 to an orientation with the first flat edge 220 disposed against and engaging an actuation surface 224 of the central opening 172 of the valve arm 152. Due to the half-circle configuration of the cam 194 and the smaller dimension of the first distance 226, positioning the first flat edge 220 against the actuation surface 224 provides room for the valve arm 152 to translate in the direction of the second orifice 146. The additional translation room allows the spring 166 to expand, bias and translate the valve arm 152 against the second fitting 136, thereby covering and closing the second orifice 146. In the open position (e.g., the second orifice 146 is open), the lever arm 192 can be rotated to the second endpoint position, resulting in rotation of the cam 194 to an orientation with the second flat edge 222 disposed against and engaging the actuation surface 224 of the central opening 172 of the valve arm 152. Due to the larger dimension of the second distance 228, positioning the second flat edge 222 against the actuation surface 224 translates the valve arm 152 away from the second fitting 136, overcomes the bias of the spring 166 and compresses the spring 166, thereby uncovering and opening the second orifice 146. Thus, closing and opening of the second orifice 146 is accomplished via spring pressure and is preferably not required to be dependent on tight tolerances.

Due to the orientation of the first and second flat edges 220, 222, the difference in dimension of the first and second distances 226, 228 of the cam 194, and the continued biasing force of the spring 166, a spring-loaded snapping action is generated that prevents the lever arm 192 from being positioned at an intermediate position between the first and second endpoint positions. Thus, the snapping action ensures that the valve arm 152 is either in an open position or a closed position, preventing undesired gas flow through the second orifice 146. As a result, the exemplary device 100 allows for switching between two different gas types while maintaining proper gas flow through the device 100.

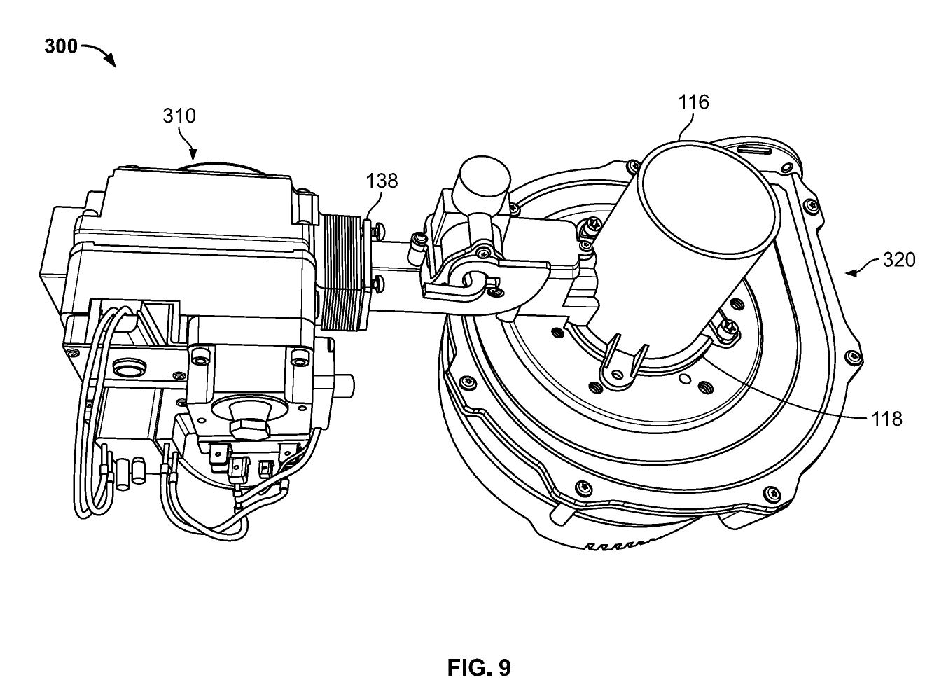

FIGS. 8 and 9 provide perspective views of a prototype 300 of the exemplary device 100. The prototype 300 is substantially similar in structure and function to the device 100. Therefore, like reference numbers represent like structures. In FIG. 9, the prototype 300 is mounted between a gas valve 310 and a blower 320 of a swimming pool heater. In particular, the inlet 138 of the prototype 300 is mounted to the outlet of the gas valve 310 and the outlet 118 is mounted to the inlet of the blower 320. The design of the prototype 300 allows the swimming pool heater to function with two different types of gases and ensures that proper gas flow is passing through the swimming pool heater.

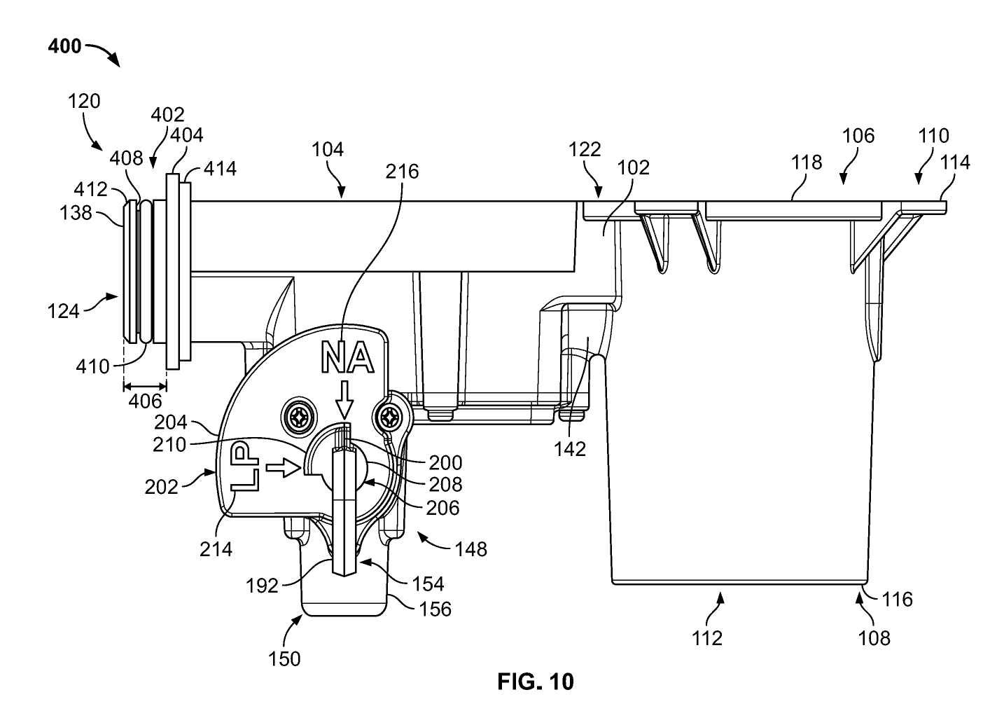

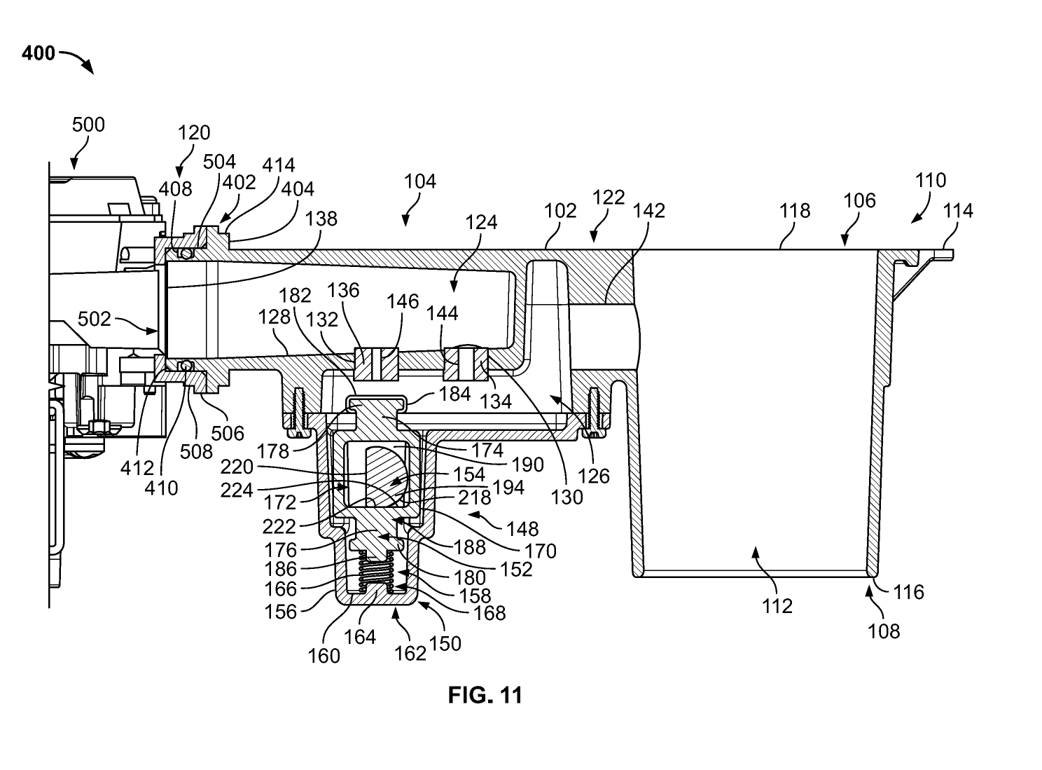

With reference to FIGS. 10 and 11, side and cross-sectional views of a second embodiment of an exemplary gas switching device 400 (hereinafter “device 400”) are provided. The device 400 can be substantially similar in structure and function to the device 100, except for the distinctions noted herein. Therefore, like reference numbers are used to describe like structures.

In particular, rather than including a circumferential flange 140 directly at the proximal end 120 for attachment of the proximal end 120 to a gas source (e.g., a gas valve), the proximal end 120 of the device 400 can define a piston style O-ring connection mechanism 402 (e.g., a mating connector). The connection mechanism 402 generally includes a circumferential flange 404 spaced from the proximal end 120 by a distance 406. The flange 404 can define a circumferential step 414. In between the proximal end 120 and the circumferential flange 404, the connection mechanism 402 includes a circumferential groove 408 configured and dimensioned to receive therein a seal 410 (e.g., an O-ring). In some embodiments, the proximal end 120 can include an outwardly tapered inlet edge 412.

FIG. 11 shows the proximal end 120 of the device 400 mated relative to a gas source 500 (e.g., a gas valve). The gas source 500 generally includes a receiving portion 502 with an opening 504 configured and dimensioned to receive the proximal end 120 of the device 400 therein. The distal end of the receiving portion 502 includes a circumferential flange 506 with a circumferential step 508. The circumferential flange 506 and circumferential step 508 can be substantially complementary to the circumferential flange 404 and circumferential step 414 of the device 400. The proximal end 120 of the device 400 can be inserted into the opening 504 the distance 406 until the circumferential flanges 404, 506 abut each other. The seal 410 maintains a fluid tight connection between the device 400 and the gas source 500.

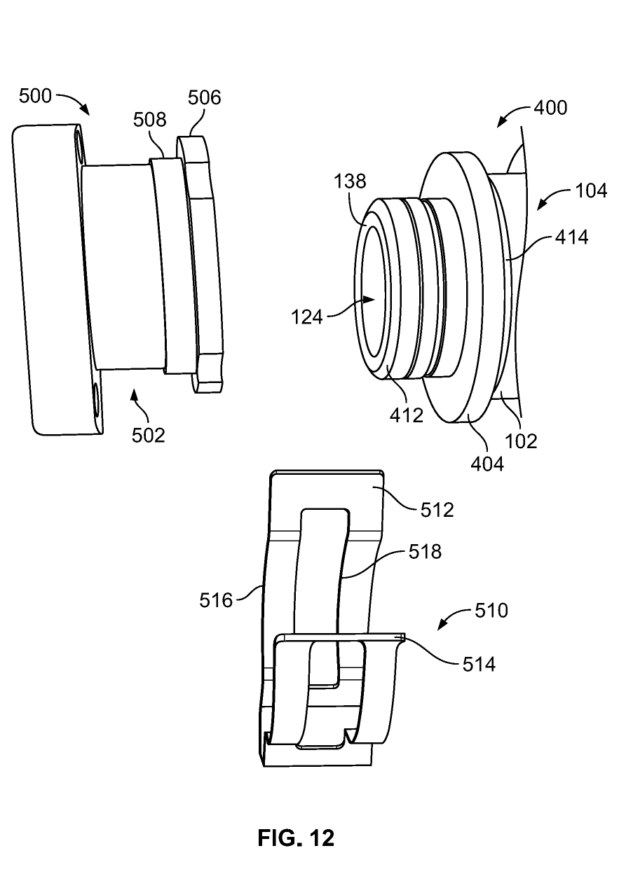

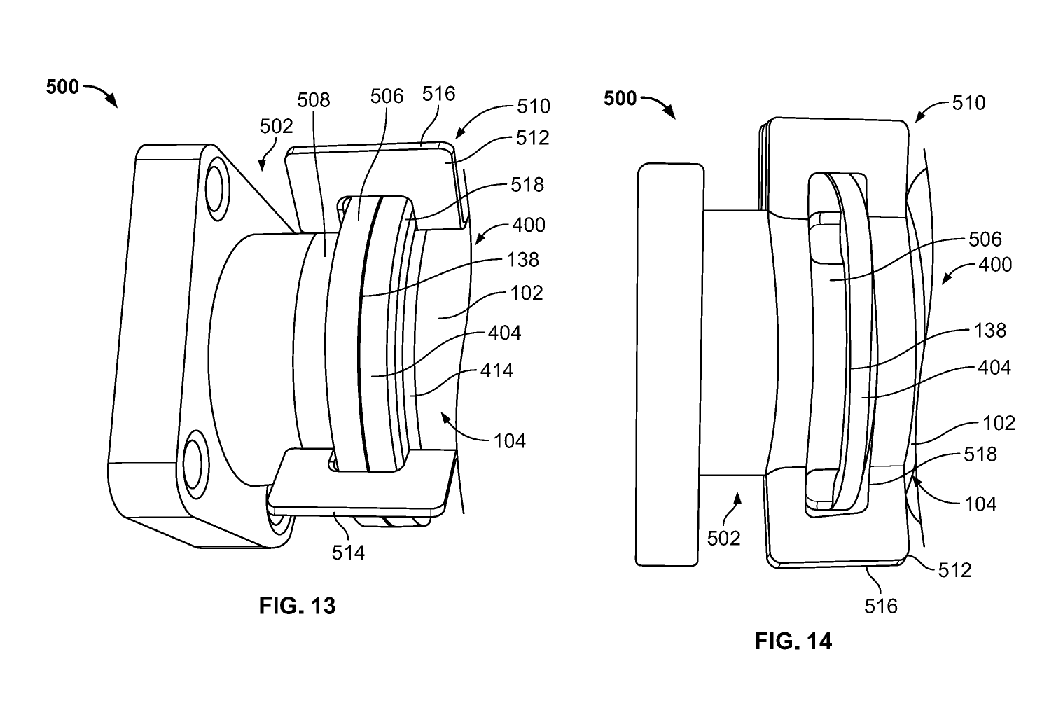

FIGS. 12-14 show disassembled and assembled views of the device 400 and the gas source 500. For clarity, only the receiving portion 502 of the gas source 500 is shown. FIG. 12 shows the device 400 and the gas source 500 prior to assembly, and FIGS. 13 and 14 show the proximal end 120 of the device 400 inserted into the receiving portion 502 of the gas source with the circumferential flanges 404, 506 abutting each other.

The assembly includes a spring retainer clip 510 for securing the device 400 relative to the gas source 500. The retainer clip 510 can define a substantially C-shaped configuration with two ends 512, 514 biased towards each other. The body 516 of the retainer clip 510 includes an elongated slot 518 extending between the two ends 512, 514. The slot 518 can be configured and dimensioned to at least partially receive therein both of the circumferential flanges 404, 506. In particular, as shown in FIGS. 13 and 14, the retainer clip 510 can be snapped over the connection mechanism formed by the abutting circumferential flanges 404, 506 such that at least a portion of the circumferential flanges 404, 506 extends into and through the slot 518. Due to the interlocked position of the circumferential flanges 404, 506 relative to the slot 518, the retainer clip 510 prevents separation between the device 400 and the gas source 500. Thus, a quick release connection mechanism can be used for connections between the device 400 and the gas source 500. The exemplary quick release mechanism provides an efficient and easy-to-use mechanism for coupling and separating the components of the assembly, and advantageously eliminates the potential problem of over-torquing threads when creating a fluid-tight seal between the components of the assembly.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A gas switching device, comprising:
a body including (i) an inlet, (ii) an outlet, (iii) a first orifice in fluid communication with the inlet, and (iv) a second orifice in fluid communication with the inlet; and
a gas selector mechanism including (i) a valve arm, and (ii) a selector element configured to actuate the valve arm between a closed position and an open position;
wherein in the closed position, the selector element actuates the valve arm to close the second orifice for passage of a first type of gas through the first orifice; and
wherein in the open position, the selector element actuates the valve arm to open the second orifice for passage of a second type of gas through both the first orifice and the second orifice.

2. The gas switching device of claim 1, wherein the first orifice is calibrated for passage of the first type of gas, and a combination of the first orifice and the second orifice is calibrated for passage of the second type of gas.

3. The gas switching device of claim 1, wherein the first type of gas is propane gas.

4. The gas switching device of claim 1, wherein the second type of gas is natural gas.

5. The gas switching device of claim 1, wherein the selector element comprises a selector lever, the selector lever comprising a lever arm and a cam.

6. The gas switching device of claim 5, comprising a gas selector cover including an opening restricting rotational motion of the lever arm to a predetermined radial distance, the predetermined radial distance including a first endpoint position and a second endpoint position.

7. The gas switching device of claim 6, wherein the predetermined radial distance is 90°.

8. The gas switching device of claim 6, wherein the first endpoint position corresponds to the closed position of the valve arm, and the second endpoint position corresponds to the open position of the valve arm.

9. The gas switching device of claim 8, wherein the valve arm comprises a central opening configured and dimensioned to receive the cam of the selector element.

10. The gas switching device of claim 9, wherein the cam defines a half-circle configuration with two flat edges.

11. The gas switching device of claim 10, wherein the two flat edges are adjacently disposed at a 90° angle.

12. The gas switching device of claim 9, wherein the two flat edges snap the cam into a position corresponding to either the first endpoint position or the second endpoint position of the valve arm, and prevent the cam from being positioned between the first endpoint position and the second endpoint position.

13. The gas switching device of claim 9, comprising a spring imparting pressure on the valve arm.

14. The gas switching device of claim 13, wherein rotating the lever arm into the first endpoint position expands the spring to impart pressure on the valve arm, the pressure on the valve arm forcing the valve arm to translate and close the second orifice.

15. The gas switching device of claim 13, wherein rotating the lever arm into the second endpoint position translates the valve arm away from the second orifice and compresses the spring to open the second orifice.

16. The gas switching device of claim 1, wherein the inlet of the body comprises a connection mechanism including a circumferential flange and a circumferential groove configured and dimensioned to receive an O-ring, the connection mechanism being configured to mate with a gas source.

17. A gas switching device, comprising:
a body including an inlet;
a first orifice in fluid communication with the inlet;
a second orifice in fluid communication with the inlet;
a valve arm; and
a selector element configured to actuate the valve arm between a closed position and an open position to close and open the second orifice, the selector element including a cam defining a half-circle configuration with two flat edges.

18. A method of switching gas, comprising:
providing a gas switching device including (i) a body including an inlet and an outlet, (ii) a first orifice in fluid communication with the inlet, (iii) a second orifice in fluid communication with the inlet, and (iv) a gas selector mechanism including a valve arm and a selector element;
actuating the valve arm with the selector element into a closed position to close the second orifice for passage of a first type of gas through the first orifice; and
actuating the valve arm with the selector element into an open position to open the second orifice for passage of a second type of gas through both the first orifice and the second orifice.

19. The method of claim 18, comprising restricting rotational motion of the selector element within an opening of a gas selector cover to a predetermined radial distance, the predetermined radial distance including a first endpoint position and a second endpoint position.

20. The method of claim 19, comprising rotating the selector element into the first endpoint position to expand a spring imparting pressure on the valve arm such that the spring imparts pressure on the valve arm to force the valve arm to translate and close the second orifice, and comprising rotating the selector element into the second endpoint position to translate the valve arm away from the second orifice and compress the spring to open the second orifice.
